(19) United States
(12) Patent Application Publication
(10) Pub. No.: US 2026/0192649 A1
(43) Pub. Date: Jul. 9, 2026

(54) AXLE OF A VEHICLE

(71) Applicant: Robert Bosch GmbH, Stuttgart (DE)

(72) Inventors: Mario Reimann, Waiblingen (DE); Jonathan Engbrecht, Flehingen (DE); Moritz Gauger, Stuttgart (DE); Peter Dengler, Stuttgart (DE); Robert Hecht, Korb (DE); Stefan Anspann, Flein (DE)

(21) Appl. No.: 18/865,621

(22) PCT Filed: Apr. 20, 2023
(86) PCT No.: PCT/EP2023/060215

§ 371 Date: Nov. 13, 2024

(30) Foreign Application Priority Data
May 30, 2022 (DE) 10 2022 205 383.4

(51) Int. Cl. B60K 1/00; B60B 35/14; B60B 35/16; B60K 17/08; B60K 17/16; F16D 55/00; F16D 65/00; F16H 57/02; F16H 57/025; F16H 57/031; F16H 57/037

(52) U.S. Cl. CPC B60K 1/00; B60B 35/14; B60B 35/16; B60K 17/08; B60K 17/165; F16D 65/0056; F16H 57/025; F16H 57/031; F16H 57/037; B60B 2900/112; B60B 2900/113; B60B 2900/115; B60B 2900/116; B60B 2900/531; B60B 2900/541; B60K 2001/001; F16D 2055/0008; F16H 2057/02026; F16H 2057/02034; F16H 2057/02052; F16H 2057/02056

(57) ABSTRACT

The invention relates to an axle (30) of a vehicle, having a first axle tube (32) and a second axle tube (34), and having brake discs (18) of a vehicle brake that are associated with each of these tubes. The axle (30) comprises, as a supporting structure (54), a system housing (38) of an electric drive unit (36) which interconnects the first and the second axle tube (32, 34). The invention further relates to the use of the axle (30) as a drive axle in an electrically driven utility vehicle, in particular in a light electrically driven utility vehicle.

### BACKGROUND

The invention relates to an axle of a vehicle having a first axle tube and a second axle tube, and having brake discs of a vehicle brake that are associated with each of these tubes. Furthermore, the invention relates to the use of the axle as a drive axle in an electrically driven utility vehicle, in particular in a light electrically driven utility vehicle.

Utility vehicles typically have driven rigid rear axles, which typically have an equalizing gear in the center. In utility vehicles, the banjo axle and funnel axle or trumpet axle are commonly used.

The design of rigid rear axles as banjo axles offers the advantage that the entire axle head including the equalizing gear can be mounted and adjusted as an assembly outside the axle housing. In the case of funnel or trumpet axles, which are typically used in light utility vehicles, for example in transporters, the axle head is divided transversely into two halves in the area of the differential gear. Although this offers cost advantages in terms of manufacture compared to the banjo axle, it does involve very complex retrofit installation and adjustment work.

### SUMMARY

The underlying object of the present invention is to provide an electrical variant of a conventionally constructed rigid rear axle for a light utility vehicle.

According to the invention, an axle of a vehicle is proposed, wherein the axle has a first axle tube and a second axle tube, and brake discs of a vehicle brake that are associated with each of these tubes. The axle comprises, as a supporting structure, a system housing of an electric drive unit which interconnects the first and the second axle tubes.

The solution proposed according to the invention enables the integration of an electric drive unit, together with components such as a multi-stage transmission, an equalizing gear (differential) and an electric machine in a common system housing, wherein the system housing of the electric drive unit forms an axle tube portion of the axle of an electrically driven vehicle when installed.

In an advantageous further development of the axle proposed according to the present invention, the electric drive unit comprises an electric machine having a rotor/stator assembly, a transmission and an equalizing gear, all of which are accommodated in the system housing of the electric drive unit.

In an advantageous embodiment of the axle proposed according to the invention, the system housing further comprises a parking lock unit.

In the axle proposed according to the present invention, the transmission closed within the system housing with a first cover, the rotor/stator assembly of the electric machine is closed with a second cover, and finally the equalizing gear is closed with a third cover. The arrangement of covers on the outside of the system housing integrated as a supporting structure in the axle allows for easy access from the outside in the event of repair or maintenance without the system housing being disassembled.

In an advantageous further development of the axle proposed according to the invention, the system housing comprises an axle tube portion having a first flange surface and a second flange surface. The flange surfaces arranged on the axle tube portion provide an interface for connection to the first axle tube and the second axle tube of the axle.

In an advantageous configuration of the axle proposed according to the invention, the first axle tube and the second axle tube are connected to the axle tube portion of the system housing at the flange surfaces via flange connections. The flanged connections between the axle tubes on the one hand and the axle tube portion in the system housing allow for cost-efficient attachment of the axle tubes to both sides of the axle tube portion of the system housing.

Alternatively, in the axle proposed according to the invention, it can be provided that the first axle tube and the second axle tube are pressed into the axle tube portion of the system housing. In this embodiment, the formation of flange surfaces and flange connections can be omitted; the first axle tube and the second axle tube can be pressed into the corresponding openings of the axle tube portion by shrink-fitting, for example. In an advantageous further development of the axle proposed according to the invention, the equalizing gear, the transmission, the rotor/stator assembly of the electric machine are accessible from the outside when installed in the axle as the supporting structure after assembly of the cover. This makes repairs and maintenance operations significantly easier to perform.

In a further highly advantageous further development of the axle proposed according to the invention, the system housing of the electric drive unit comprises connection points for longitudinal links and/or further inner longitudinal links. This allows the installation variance of the system housing to be taken into account, as different vehicle body geometries require different connection locations.

In a further development of the axle proposed according to the invention, the system housing already comprises integrated dome-shaped longitudinal link connections. If the longitudinal link connections are configured directly on the system housing, no further separate components or assembly steps are required.

In a further advantageous embodiment of the axle proposed according to the invention, a first adapter bracket and a second adapter bracket are arranged as separate components on both sides of the axle tube portion of the system housing. In this embodiment of the connection points for the longitudinal links, i.e. as separate components in the form of adapter brackets, the variance can be shifted from the system housing to the adapter brackets. This means that the system housing can be configured and produced as standard while the different installation geometries of the axle, i.e. their adaptation to different vehicle bodies or vehicle body geometries, are produced via the respective body of the adapter brackets.

In an advantageous embodiment of this solution, the adapter brackets can each have bore patterns that correspond to those of the first flange surface and the second flange surface on the front sides of the axle tube portion of the system housing. This allows a modular design to be achieved in which as many identical components as possible are used, in particular the same geometry of interfaces between the adapter brackets, the first and the second axle tube, and the axle tube portion of the system housing.

In an advantageous further development of the axle proposed according to the invention, the first axle tube and the second axle tube can be pressed, preferably shrink-fitted, into openings on the front sides of the axle tube portion of the system housing instead of flange connections. This eliminates the need for flange connections and screw connections by establishing a shrink connection between the first and second axle tube and the axle tube portion which can be manufactured without fastening components.

Alternatively, in the axle proposed according to the invention, it is also possible to connect the first and the second axle tubes by means of material-locking connections, which are preferably formed as welded connections, with steel bushings which are cast into opposite openings of the system housing.

Moreover, the invention relates to the use of the axle as the driving axis of an electrically driven utility vehicle, in particular a light electrically driven utility vehicle.

The solution proposed according to the invention allows a simple integration of an electric drive unit, including components provided therein, such as differential gears and an electric machine itself, into a rigid, multi-part, electrically driven axle of a utility vehicle. The solution proposed according to the invention allows the system housing of the electric drive unit, including the components received therein, to form a supporting structure within the axle to which a first axle tube and a second axle tube can be attached to flange connections. Advantageously, the system housing of the electric drive unit has an axle tube portion, which has flange surfaces on its two front faces, to which flange connections can fastened, preferably as simple screw connections to the corresponding ends of the first axle tube and the second axle tube.

Alternatively, the first axle tube and the second axle tube can be shrunk into the axle tube portion of the system housing so that a positive and frictional connection can be created between the axle tube portion and the two axle tubes.

Advantageously, the system housing of the electric drive unit is designed such that components joined in the common system housing in the joining direction, for example the rotor/stator assembly, gear components of a single-stage or multi-stage transmission, as well as the components of the differential gear are mounted in the joining direction. The installation openings are then closed by covers. The entire structure, i.e. the pre-assembled system housing of the electric drive unit, is an integral part of an electrical axle in the final assembly state, wherein the individual components, i.e. equalizing gear, transmission, and rotor/stator assembly of the electric machine are accessible from the outside after removal of the corresponding cover. This requires neither disassembly of the drive unit as a supporting structure from the axle itself nor further upstream assembly preparations. After removal of the covers at the corresponding openings of the system housing, the mentioned components are accessible from the outside. This makes maintenance and repair work considerably easier.

In the solution proposed according to the invention, a variance in relation to the connection points of the system housing of the electric drive unit can be improved during its integration into the axle by, for example, arranging the adapter brackets laterally on front faces of the axle tube portion of the system housing. The adapter brackets can be configured as separate components, which are provided with a receiving fork into which, for example, further internally arranged longitudinal links are included, which allow the axle to be connected to the different vehicle geometries of the vehicle bodies and guide the axle. On the one hand, the longitudinal link connection points can be configured as separate components in the form of adapter brackets; it is also possible to design connection points for the longitudinal links as dome-shaped elevations integrated into the system housing. In this case too, the configuration of the longitudinal link connection points can take account of different installation configurations at the vehicle manufacturers and the variance may be shifted from the system housing of the electric drive unit to the configuration of the longitudinal links.

By forming a first flange connection and a second flange connection between the first axle tube, the second axle tube and the axle tube portion of the system housing of the electric drive unit, a standard interface can be established in the area of the front faces of the axle tube portion of the system housing on the one hand and the first and the second axle tube on the other. Flange connections allow the first axle tube and the second axle tube to be pressed into the openings of the axle tube portion of the system housing, preferably by means of a shrink connection. This provides the advantage that separate screw connections, the formation of bore patterns in the flange surfaces and the like, as well as complex assembly steps can be omitted.

A further configuration possibility for a connection between the first and the second axle tube and the axle tube portion of the system housing is that steel bushings can be cast into the system housing, for example. Between the inner circumferential surfaces of these steel bushings, which are cast into the system housing on opposite openings, and the outer circumferences of the axle tubes, for example, material-locking joint connections can be provided in the form of weld seams. In this way, a supporting structure can also be established between the system housing and the axle tubes of the axle proposed according to the invention.

### BRIEF DESCRIPTION OF THE DRAWINGS

The invention is described in greater detail below with reference to the drawings.

Shown are:

FIG. 1 a conventional rigid axis of a light utility vehicle with a equalizing gear centrally accommodated therein,

FIG. 2 a top perspective view of an axle proposed according to the invention with an electrical drive unit integrated as a supporting structure between a first axle tube and a second axle tube,

FIG. 3 a sectional view of the axis according to FIG. 2, wherein the sectional plane passes through the axle tubes and partially through the system housing,

FIG. 4 a top perspective view of the electric drive unit,

FIG. 5 an exploded view of the electric drive unit with the components mounted in its system housing in the joining directions and finally shielded from the outside by means of corresponding covers,

FIG. 6 a cut-away representation of the equalizing gear,

FIG. 7 a plan view of a system housing of an electric drive unit with laterally arranged adapter brackets,

FIG. 8 a side view of an adapter bracket mounted laterally on the system housing,

FIG. 9 an electrical drive unit as a supporting structure between two axle tubes, together with link connections for further longitudinal links arranged inside,

FIG. 10 a perspective view of a steel bushing cast into the system housing, to which a first axle tube is connected in a material-locking manner, and

FIG. 11 the system housing with power electronics housed therein.

### DETAILED DESCRIPTION

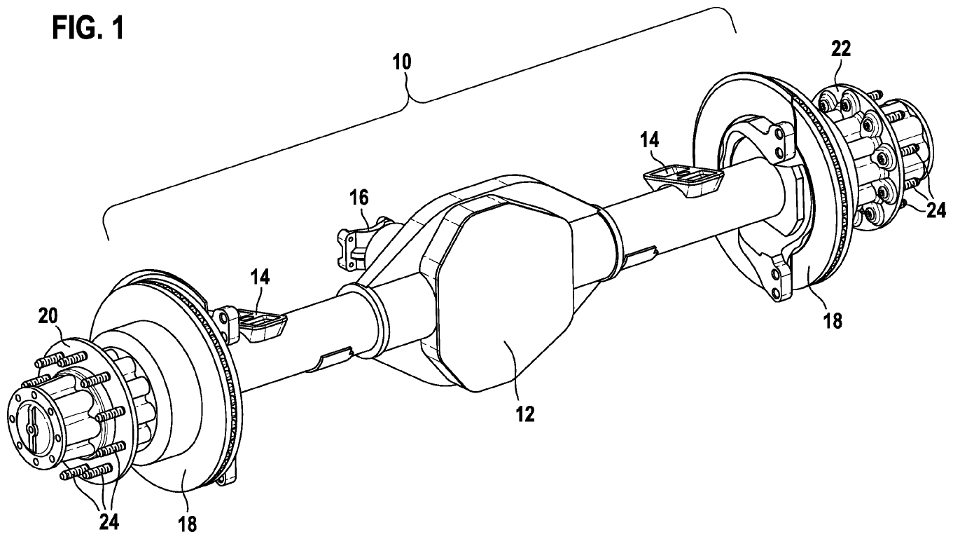

FIG. 1 shows a view of a rigid axis 10 of a light utility vehicle. The rigid axis 10 according to the perspective view in FIG. 1 comprises a differential gear 12 and a plurality of axle connections 14, via which the rigid axle 10 is connected to the body of a light utility vehicle, which is not shown detail here.

The equalizing or differential transmission 12 of the rigid axle 10 comprises an input 16 for a drive shaft driven by a drive unit of the vehicle.

Brake discs 18 of a vehicle brake are provided at the two ends of the rigid axle 10; furthermore, a first and a second wheel hub 20, 22, which have a number of wheel bolts 24 to which the wheels are fastened which are driven via the rigid axle 10, are located at the respective ends of the rigid axle 10.

In the following description of the embodiments of the invention, identical or similar elements are denoted by identical reference signs, whereby a repeated description of these elements is omitted in individual cases. The drawings show the subject matter of the invention only schematically.

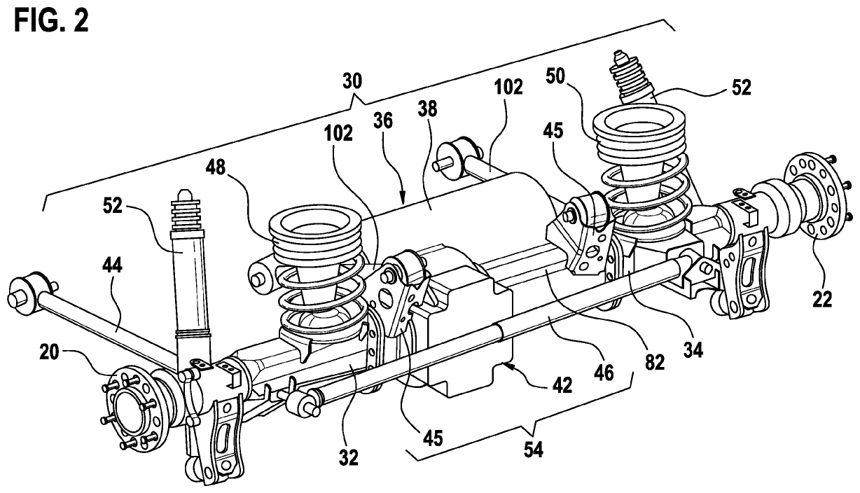

FIG. 2 shows a perspective view of an assembly of an axle 30 proposed according to the present invention for an electrically driven light utility vehicle.

From the illustration according to FIG. 2, it can be seen that an axle 30 comprises axle tubes receiving the first and second wheel hubs 20, 22, namely a first axle tube 32 and a second axle tube 34. An electric drive unit 36 is located between the two axle tubes 32, 34 of the axle 30 according to the perspective view in FIG. 2. The electric drive unit 36 comprises, in addition to an electric machine, a multi-stage transmission 40 as well as an equalizing gear 42, which is also referred to as a differential. The components of the electric drive unit 36, namely the electric machine, the multi-stage gear 40, and the equalizing gear 42, are all housed in one of these components common to the system housing 38. An axle tube portion 82 is located on the system housing 38, from which longitudinal link connections 45 extend as shown in FIG. 2. A pair of further longitudinal links 102 are mounted in the ends of the longitudinal link connections 45.

The axle 30 shown in perspective view in FIG. 2 also comprises a wishbone 46, which is linked to the first axle tube 32 and the second axle tube 34. FIG. 2 also shows that the system housing 38 of the electric drive unit 36 forms the supporting structure 54, which forms the axle 30 having the first axle tube 32 and the second axle tube 34. Shock absorbers 52 extend parallel to spring members 48, 50, with which the axle 30 is connected to a body of an electrically driven vehicle not shown in detail here.

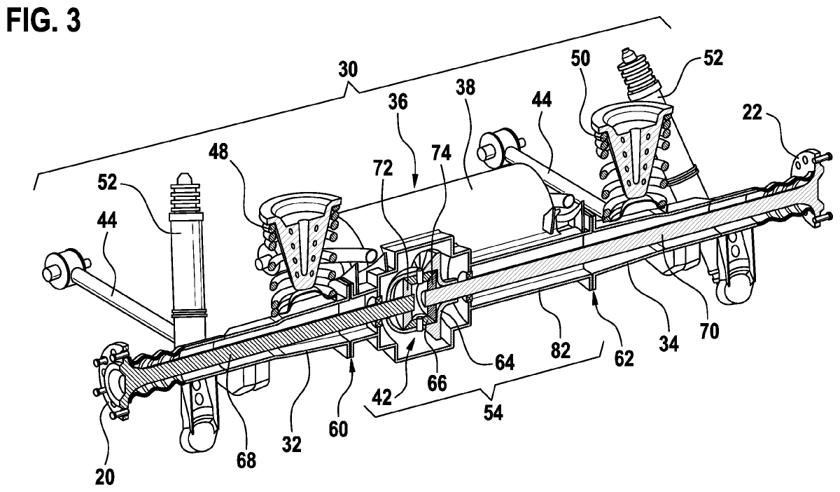

FIG. 3 shows a section through axis 30, wherein the section runs through the axis of symmetry of the output shafts 68, 70.

FIG. 3 shows that the system housing 38 of the electric drive unit 36 forms the supporting structure 54 between the first axle tube 32 and the second axle tube 34. The hollowly formed axle tubes 32, 34 receive the first output shaft 68 and the second output shaft 70. Pinion gears 72, 74 thereof are driven via the equalizing gear 42. This is also shown in cut-away in the illustration in FIG. 3. The sectional view in FIG. 3 shows that a differential cage 64 of the equalizing gear 42 is driven via a differential gear 66. The pinions 72, 74, via which the first output shaft 68 and the second output shaft 70 opposite it are driven, are part of the equalizing gear 42.

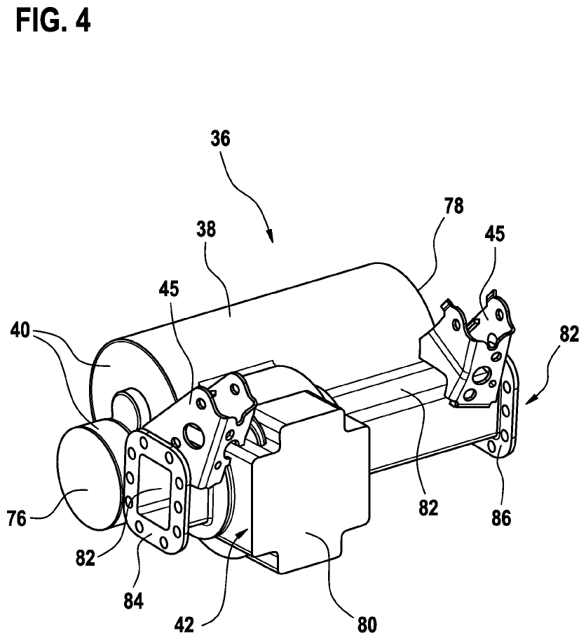

The output shafts 68, 70 driven via the pinions 72, 74 extend through the axle tube portion 82 of the system housing 38. The axle tube portion 82 comprises flange surfaces 84, 86 at its ends (see representation in FIG. 4). There, the first axle tube 32 and the second axle tube 34 are bolted to the axle tube portion 82 of the system housing 38, for example, via a first flange connection 60 and via a second flange connection 62. Consequently, the axle tubes 32, 34 screwed together at the flange surfaces 84, 86 (see. FIG. 4) with the axle tube section 82 form the axle 30, wherein the system housing 38 of the electric drive unit 36 forming the supporting structure 54 is integrated into the axle 30 according to the illustrations in FIGS. 2 and 3.

FIG. 4 shows, in perspective view, the electric drive unit 36.
the illustration in FIG. 4 shows that the system housing 38 of the electric drive unit 36 comprises the axle tube portion 82. The aforementioned first flange surfaces 84 and aforementioned second flange surfaces 86, as already mentioned above in connection with FIGS. 2 and 3, are located on its front faces. For example, the first and second flange surfaces 84, 86 of the axle tube portion 82 are provided with a number of bores such that the first axle tubes 32 and second axle tubes 34 may be screwed onto the first flange surface 84 and the second flange surface 86 not shown in FIG. 4. Starting from the axle tube portion 82 of the system housing 38, which is also hollowly formed, the longitudinal link connections 45 extend upwardly in the vertical direction when viewed from the top of the axle tube portion 82.

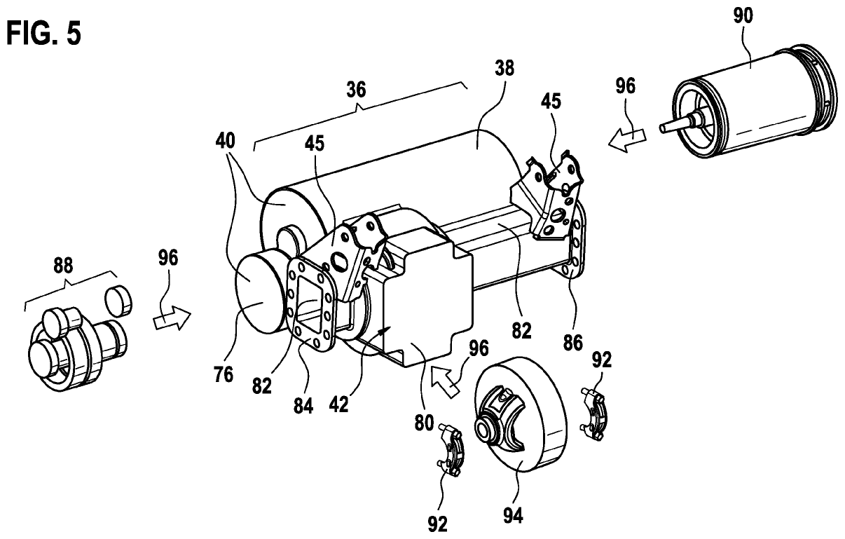

The illustration according to FIG. 4 furthermore shows that, for example, a first cover 76 is provided on the transmission side of the system housing 38. The first cover 76 closes an opening through which the multi-stage transmission 40 is installed in the system housing 38 of the electric drive unit 36. A second cover 78 is on the face of the system housing 38 opposite the multi-stage transmission 40. The second cover 78 closes an opening in the system housing 38 of the electric drive unit 36, via which an electric machine or its rotor/stator assembly 90 (cf. exploded view according to FIG. 5) is mounted in the system housing 38. Finally, FIG. 4 shows a third cover 80 closing an opening in the system housing 38 in which the equalizing gear box 42 is accommodated.

The electric drive unit 36 shown in perspective view in FIG. 4, which is provided with removable covers 76, 78, 80, is extremely compact and, in addition to the components already listed above, may be provided with a parking lock unit, which can also be integrated into the system housing 38 of the electric drive unit 36.

FIG. 5 shows the electric drive unit 36 according to the illustration in FIG. 4 as an exploded view. The illustration according to FIG. 5 shows that in this exploded view of the electric drive unit 36, the first cover 76, the second cover 78 and the third cover 80 each close openings in the system housing 38 that correspond to these. Upon removal of said covers 76, 78, 80, the components of the electric drive unit 36 may be mounted into the system housing 38.

After removal of the first cover 76 on the transmission side of the system housing 38, transmission components 88 of the multi-stage transmission 40 are mounted there in the joining direction 96 in the system housing 38. After removal of the second cover 78 opposite the first cover 76 and release of the corresponding opening of the system housing 38, a rotor/stator assembly 90 of an electric machine is inserted there in the joining direction 96 into the system housing 38 of the electric drive unit 36, also in the joining direction 96.

Finally, after removal of the third cover 80, components 94 of the equalizing gear 42 are inserted into the system housing 38. The components 94 of the equalizing gear box 42 are also joined in the joining direction 96 in the corresponding opening and the corresponding cavity of the common system housing 38 of the electric drive unit 36 by means of bearing half-shells 92. After joining said components in the system housing 38, the openings in the system housing 38 are resealed by the first cover 76, the second cover 78, and the third cover 80.

Such a pre-assembled electric drive unit 36, for example, is pre-assembled as shown in FIG. 5 and integrated as a supporting structure 54 into the axle 30 according to the illustrations of FIGS. 2 and 3. The integration of the electric drive unit 36 as a supporting structure 54 into the axle 30 is carried out by means of the first flange surface 84 or the second flange surface 86 on the front faces of the axle tube portion 82 of the system housing 38. According to the sizing, the flange faces 84, 86 are configured with a number of openings to create the first and second flange connections 60, 62.

On the top side of the axle tube portion 82, which is also integrated into the system housing 38, said longitudinal link connections 45 extend substantially upwards in an inclined vertical direction. Further inner longitudinal links 102 shown in FIG. 2 are linked thereto in order to be able to accommodate different variants of the electric drive unit 36 with respect to the connection of longitudinal links 44 and further inner longitudinal links 102.

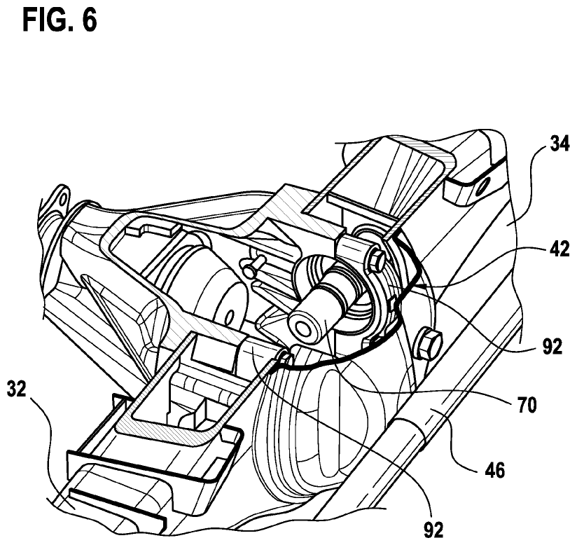

FIG. 6 shows a cut-away representation of the equalizing gear 42.

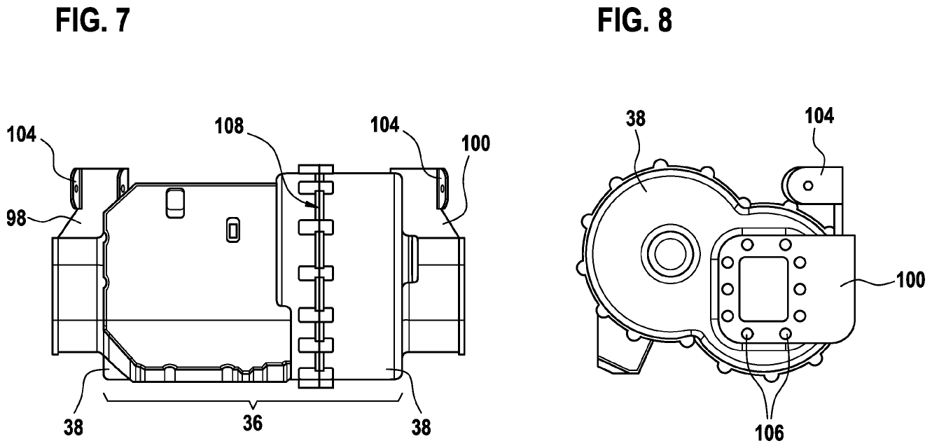

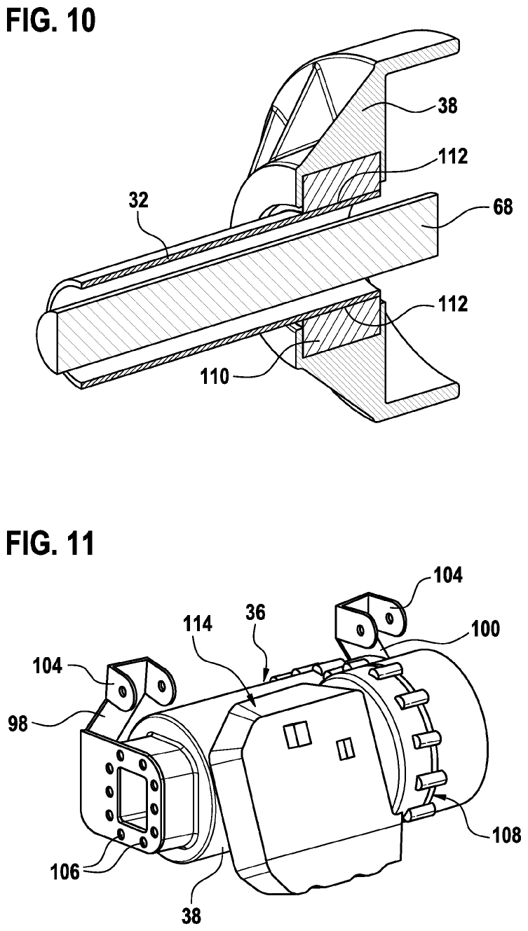

From FIG. 6 it can be seen that an equalizing gear 42 is installed as a sub-assembly in the system housing 38. The differential body is mounted with its main bearings longitudinally in the vehicle direction in the system housing 38. The two bearing seats of the main bearings are split, with one half of the split bearing seats being located in the system housing 38 and their counterparts being formed by the two bearing half-shells 92 already shown in FIG. 5. These are screwed to their counterparts within the system housing 38. The advantage of this type of assembly is that the system housing 38 may be embodied as a one-piece support structure 54. Alternatively, it is possible to split the system housing 38 approximately in the center into two halves in the longitudinal direction of the vehicle, see FIGS. 7 and 11.

The illustration according to FIG. 7 shows the top plan view of the system housing 38. In the illustration according to FIG. 7, the system housing 38 of the electric drive unit 36 is split along a dividing plane 108; furthermore, a first adapter bracket 98 and a second adapter bracket 100 are located on the front faces of the system housing 38. The adapter brackets 98, 100 may be configured on the axle tube portion 82 of the system housing 38 as an alternative to the longitudinal link connections 45 shown in FIGS. 4 and 5. In the illustration according to FIG. 7, the adapter brackets 98, 100 represent separate components that have lateral plate-like surfaces provided with a bore pattern 106 complementary to the first flange surface 84 and to the second flange surface 86 with respect to bores. In the upper region of the first adapter bracket 98 as well as the second adapter bracket 100, there are receiving forks 104, to which the further inner longitudinal links 102 are linked.

Depending on the configuration of the adapter bracket units 98, 100, different installation variants or receiving variants of the further inner longitudinal links 102 can be taken into account, so that the installation variance of the electric drive unit 36 or its connection to a chassis of a light electrically driven utility vehicle can be significantly extended.

Also, the configuration of the receiving forks 104 configured in the upper region of the first adapter bracket 98 and the second adapter bracket 100 may be adapted to different installation requirements. While the longitudinal link connections 45 shown in FIGS. 4 and 5 are directly connected to the system housing 38 of the electric drive unit 36, the first adapter bracket 98 and the second adapter bracket 100 represent separate components that can be mounted laterally to the front faces of the system housing 38.

A side view of the system housing 38 is shown in FIG. 8. In the illustration according to FIG. 8, the second adapter bracket 100 is arranged laterally on the system housing 38 and covers the second flange surface 86 configured on the system housing 38 with its bore pattern 106. The bore pattern 106 of the second adapter bracket 100 and the second flange surface 86 of the axle tube portion 82 are arranged in complementary fashion to each other.

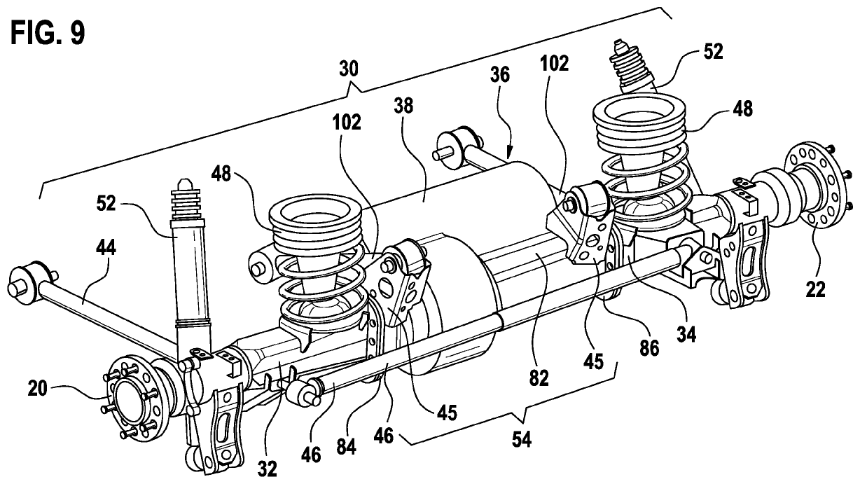

FIG. 9 shows the axle 30, which, apart from the geometry of the system housing 38 of the electric drive unit 36, has a similar design to the axle 30 shown in FIGS. 2 and 3. The perspective view according to FIG. 9 shows that the electric drive unit 36 is a supporting structure 54 of the axle 30. The first and second flange connections 60, 62 (cf. FIG. 3) are implemented on the first and second flange surfaces 84, 86, such that the assemblies of the first axle tube 32, electric drive unit 36 and second axle tube 34 represent the essential components of the axle 30. FIG. 9 further shows that the axle 30 comprises a first wheel hub 20 and a second wheel hub 22 at the ends of the first axle tube 32 as well as the second axle tube 34 respectively. The first axle tube 32 and the second axle tube 34 are connected to each other via a wishbone 46. Each of the two axle tubes 32, 34 comprises the longitudinal link 44, with which the axle 30 is connected to the body of a utility vehicle, in particular an electrically driven light utility vehicle, when mounted. The first and second spring members 48, 50 are representative of attachment options of the axle 30 having the body of a light utility vehicle or an electrically driven light utility vehicle. The spring elements 48, 50 are representative of leaf springs, spiral springs or air spring bellows, thereby necessitating different configurations of longitudinal links 44 and further inner longitudinal links 102 for guiding the axle 30. There is currently a high degree of variance in the connection of conventional axles, in particular rigid axles 10 (cf. FIG. 1) due to the different vehicle types and chassis geometries. The different first and second spring elements 48, 50 may be leaf springs, spiral springs, air spring bellows, and the like, and require different longitudinal links 44 or longitudinal links 102 located further inwards to guide the axle 30. In the axle 30 proposed according to the invention, this variance is not to be represented in the system housing 38 of the electric drive unit 36, but rather in the axle tubes 32, 34 which are flanged to the system housing 38, or in the longitudinal link connections 45 or on the separate adapter brackets 98, 100, as described in connection with FIGS. 7 and 8.

For the sake of completeness, it should be mentioned that the axle 30 shown in perspective view in FIG. 9 comprises the shock absorbers 52 and partially shown longitudinal links 44 for guiding and connecting the axle 30 to the body of the vehicle.

Although integration of the system housing 38 of the electric drive unit 36 via the first and second flange connections 60, 62 to the first axle tube 32 and to the second axle tube 34 is shown above, a further connection option is to press the first axle tube 32 and the second axle tube 34 into the axle tube portion 82 or its end face openings, for example by means if a shrink connection. In this case, the formation of the first and second flange surfaces 84, 86 on the end faces of axle tube portion 82 could be omitted.

FIG. 10 shows an embodiment of a connection between the first axle tube 32 and the system housing 38. To this end, a steel bushing 110 is cast into the system housing 38 of the electric drive unit 36 which is not shown here. The steel bushing 110 extends fully around the first axle tube 32 and is connected to its outer housing by a material-locking connection 112.

Preferably, the material-locking connection 112 as shown in FIG. 9 between the steel bushing 110 and the first axle tube 32 may preferably be represented by a welded connection. In this case, the first output shaft 68 extends through the hollow first axle tube 32 to a wheel of a light utility vehicle, in particular an electrically driven light utility vehicle, which is not shown in detail here, in analogy to the above illustrations, in particular to the sectional view according to FIG. 3.

The solution proposed according to the invention can take into account the high variance with regard to the assembly of the axle 30 on different vehicle types and chassis geometries. Thus, the longitudinal link connections 45 can be configured as components integrated into the axle tube portion 82 of the system housing 38; furthermore, it is also possible to design the longitudinal link connections 45 such that they can be configured as first and second adapter brackets 98, 100 and are thus present as separate components. The axle 30 proposed according to the invention is further characterized in that when the electric drive unit 36 is mounted, i.e. flange connections 60, 62 with the first axle tube 32 or with the second axle tube 34 are present, accessibility of the system housing 38 for maintenance and repair purposes is maintained. After assembly of the respective covers 76, 78, 80 as described above, accessibility from the outside for carrying out maintenance and repair work is possible even when the electric drive unit 36 is installed in the axle 30, without the need to remove the system housing 38 of the electric drive unit 36 from the axle 30.

FIG. 11 shows the system housing 38 with power electronics 114 incorporated therein.

FIG. 11, shown in perspective, shows that power electronics 114 can be arranged above or to the side of the system housing 38. In the illustration according to FIG. 11, the housing of the power electronics 114 is integrated into the system housing 38. However, an electrical connection between the system housing 38 for the electric machine and the power electronics 114 may also be provided with an electrical connection in the form of a cable. Power electronics 114 may be integrated with their housing in the system housing 38 and may be electrically connected to the electric machine within the system housing 38. The provision of an external electrical connection in the form of an electrical cable can be omitted.

The invention is not limited to the exemplary embodiments described herein and the aspects highlighted thereby. Rather, within the range specified by the claims, a plurality of modifications is possible, which lie within the abilities of a skilled person.

1. An axle (30) of a vehicle having a first axle tube (32) and a second axle tube (34), and having brake discs (18) of a vehicle brake that are, associated with each of these tubes, wherein the axle (30) comprises, as a supporting structure (54), a system housing (38) of an electric drive unit (36) which interconnects the first and second axle tubes (32, 34).

2. The axle (30) according to claim 1, wherein the electric drive unit (36) comprises an electric machine having a rotor/stator assembly (90) a multi-stage transmission (40), and an equalizing gear (42) accommodated in the system housing (38).

3. The axle (30) according to claim 1, wherein the system housing (38) comprises a parking lock unit.

4. The axle (30) according to claim 2, wherein in the system housing (38), the multi-stage transmission (40) is closed with a first cover (76), the rotor/stator assembly (90) of the electric machine is closed with a second cover (78), and the equalizing gear (42) is closed with a third cover (80).

5. The axle (30) according to claim 1, wherein the system housing (38) comprises an axle tube portion (82) having a first flange surface (84) and a second flange surface (86).

6. The axle (30) according to claim 5, wherein the first axle tube (32) and the second axle tube (34) are connected to the axle tube portion (82) of the system housing (38) at the first and second flange surfaces (84, 86) via flange connections (60, 62).

7. The axle (30) according to claim 5, wherein the first axle tube (32) and the second axle tube (34) are pressed into the axle tube portion (82) of the system housing (38).

8. The axle (30) according to claim 4, wherein the equalizing gear (42), the multi-stage gear (40) and the rotor/stator assembly (90) of the electric machine are accessible from an outside when the system housing (38) is installed in the axle (30) as the supporting structure (54) after disassembly of the covers (76, 78, 80).

9. The axle (30) according to claim 1, wherein the system housing (38) comprises connection points (45; 98, 100) for longitudinal links and/or further inner longitudinal links (102).

10. The axle (30) according to claim 9, wherein the system housing (38) comprises dome-shaped longitudinal link connections (45) integrated therein.

11. The axle (30) according to claim 9, wherein first adapter bracket (98) and a second adapter bracket (100) are arranged on both sides of an axle tube portion (82) of the system housing (38) as separate components.

12. The axle (30) according to claim 11, wherein the adapter brackets (98, 100) each have bore patterns (106) corresponding to those of a first flange surface (84) and a second flange surface (86) on front faces of an axle tube portion (82) and the adapter brackets (98, 100) have receiving forks (104) for fastening the further inner longitudinal links (102).

13. The axle (30) according to claim 1, wherein the first and second axle tubes (32, 34) are pressed, into front faces of an axle tube portion (82) of the system housing (38).

14. The axle (30) according to claim 1, wherein the first and second axle tubes (32, 34) are connected to steel bushings (110) that are cast into opposing openings of the system housing (38) by material-locking connections (112).

15. (canceled)

16. The axle (30) according to claim 13, wherein the first and second axle tubes (32, 34) are shrink-fitted, into the front faces of the axle tube portion (82) of the system housing (38).

17. The axle (30) according to claim 14, wherein the first and second axle tubes (32, 34) are connected to the steel bushings (110) that are cast into opposing openings of the system housing (38) by welded connections (112).

18. A light utility vehicle comprising the axle (30) according to claim 1.

19. The light utility vehicle according to claim 18, wherein the light utility vehicle is electrically-driven.
